(19) United States
(12) Patent Application Publication
(10) Pub. No.: US 2014/0272816 A1
(43) Pub. Date: Sep. 18, 2014

(54) MULTI-DAY MEAL PREPARATION INSTRUCTION GENERATION

(71) Applicant: Tricia Callahan, Fairborn, OH (US)

(72) Inventor: Tricia Callahan, Fairborn, OH (US)

(21) Appl. No.: 14/211,637

(22) Filed: Mar. 14, 2014

Related U.S. Application Data
(60) Provisional application No. 61/790,869, filed on Mar. 15, 2013.

(51) Int. Cl. G06F 17/30

(52) U.S. Cl. CPC G06F 17/30
USPC 434/127

(57) ABSTRACT

A computing system accepts user selection and/or performs automatic selection of recipes. In various embodiments, the system produces shopping lists, task lists, pre-cooking-day preparation lists, labels for freezing, and the like so that preparation for several days' worth of meals can be accomplished by a given number of people in one cooking day of a given length, for example. The organization of preparation tasks is, in some embodiments, optimized for efficient use of preparation resources, such as ovens, mixers, and counter space. In certain embodiments, the system automatically converts ingredients between units in which they are typically purchased and units in which they are used in cooking. Various embodiments produce grocery shopping lists, chopping (ingredient preparation) lists, preparation instruction lists, freezing and serving instructions, freezer labels, and reminder messages.

### REFERENCE TO RELATED APPLICATION

This is a nonprovisional of, and claims priority to, U.S. Application No. 61/790,869, filed Mar. 15, 2013, with title MULTI-DAY MEAL PREPARATION INSTRUCTION GENERATION. The entirety of that application is incorporated by reference herein.

### FIELD OF THE DISCLOSURE

The present disclosure is directed to systems and methods for helping families fill their freezers with homemade meals by creating menus for multiple meals using seasonal recipes.

### BACKGROUND

Preparing home-cooked meals is widely appreciated as a healthy, though time-consuming, alternative to pre-packaged and restaurant meals. Unfortunately, home-cooked meals often require time-consuming preparation and clean-up, so busy families struggle to take advantage of this option. Improved systems, methods, and the like are needed to meet the needs of busy families trying to eat well.

Existing technology enables a user to create a menu plan of their choosing and receive an automatically created grocery list and/or calendar display of a consolidated list of those menu items. Still, there is a need for improvements in the area of meal preparation, shopping, storage, and retrieval.

Families find themselves busier and busier today with little to no time to make a home-cooked meal. The desire is there, but the execution can be overwhelming. Freezer cooking according to some embodiments of the disclosed system allows a family to make a majority of their meals for an extended period of time (one week, two weeks, one month, or more) in one cooking day. However, freezer cooking isn't as simple as preparing a bunch of recipes and freezing them. Recipes must be scaled to the family size and chosen for length of time desired to spend in the kitchen cooking, preparation resources available, ingredients desired, and recipe types. Once recipe selections are made, the real challenge becomes producing efficient grocery lists, step-by-step instructions (ensuring efficient and effective time in the kitchen), chopping lists, and labels.

The system described herein goes beyond compiling recipes into meal plans to provide users with a full-fledged customizable freezer cooking plan that includes recipe cards, a grocery list, a chopping list, step-by-step instructions, a thawing list, calendar/notifications, and labels.

### BRIEF SUMMARY

The present disclosure describes a system, method, apparatus, and associated computer-readable media that enables a user to select a plurality of recipes, whether from a single online resource or multiple resources, and automatically prepare a list of preparation steps useful to make those recipes such that the resulting meals are suitable for freezing. In variations, the system also automatically prepares a list of ingredient preparation steps, freezing and serving instructions, and labels for storage of prepared items in a freezer or elsewhere.

In some disclosed embodiments, automatically generated food preparation steps include conversions between units of food as purchased and units of food as processed, such as converting raw carrots measured in pounds into shredded carrots measured in cups. In variations, recipe requirements are converted into units suitable for grocery shopping, and requirements of multiple recipes (even those wherein the same raw ingredient is differently prepared, such as sliced versus chopped vegetables) are combined into a single grocery list that uses units suitable for purchase.

In other disclosed embodiments, automatically generated food preparation steps are organized to efficiently use baking, cooking, handling, and packaging resources like mixers, ovens, pans, cutting boards, slow cookers, and baking dishes. In variations, preparation of baked items in monotonically increasing order of oven temperature. In others, items to be cooked in a slow cooker are started before baked items, stove-top items, and no-baked items so that the slow-cooker items can cook while the other items are being prepared.

### DESCRIPTION OF THE DRAWINGS

FIG. 1 is a block diagram of a computing system according to one embodiment.

FIG. 2 is a wireframe/screenshot of a webpage for menu selection parameter choices according to the embodiment of FIG. 1.

FIG. 3 is a wireframe/screenshot of a webpage for making additional choices of menu selection parameters according to the embodiment of FIG. 1.

FIG. 4 is a wireframe/screenshot of a webpage displaying and accepting correction of choices of menu selection parameters that result in typically infeasible constraints.

FIG. 5 is a wireframe/screenshot of a webpage displaying and accepting correction of choices of menu selection parameters that result in conflicting constraints.

FIG. 6 is a wireframe/screenshot of a webpage for accepting user input of recipe selections and/or instructions to automatically select recipes, along with information concerning the selections.

FIG. 7 is a wireframe/screenshot of a webpage for adding recipes and displaying and providing feedback concerning recipe selections.

FIG. 8 is a wireframe/screenshot of another webpage for adding recipes and displaying and providing feedback concerning recipe selections.

FIG. 9 is a wireframe/screenshot of a webpage for displaying recipe selection conflicts and proposed resolutions.

FIG. 10 is another wireframe/screenshot of a webpage for displaying recipe selection conflicts and proposed resolutions.

FIG. 11 is a wireframe/screenshot of a webpage for presenting options to users when a selected menu is complete, but violates one or more menu option rules.

FIG. 12 is a wireframe/screenshot of a webpage for acknowledging complete menu selections and giving a user the option to add details before continuing.

FIG. 13 is a wireframe/screenshot of a webpage for accepting additional menu details from a user.

FIG. 14 is a wireframe/screenshot of a webpage for accepting user input of cooking days and serving days for various menu items.

FIG. 15 is a wireframe/screenshot of a webpage for accepting user selection of notifications before significant events in preparing and serving selected menu items.

FIG. 16 is a wireframe/screenshot of a webpage for displaying information about a completed menu selection, modification, review, or other treatment.

FIG. 17 is a wireframe/screenshot of a webpage for accepting user selection of options for producing human-readable versions of various output documents.

FIG. 18 is an entity diagram reflecting relationships between data objects in the embodiment of FIG. 1.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the disclosure or invention is thereby intended; any alterations and further modifications of the described or illustrated embodiments, and any further applications of the principles of the invention as illustrated therein are contemplated as would normally occur to one skilled in the art to which the invention relates.

### Overview

In various embodiments, menus use the system's own recipes, recipes entered by the user, recipes from elsewhere on the internet, and recipes from other available sources, combining and adapting them for freezer- and/or storage-friendly preparation. In some embodiments, a freezer cooking menu includes the following elements:
Recipe Cards. These automatically generated “virtual cards” include recipe title, source, servings yielded, ingredients needed, prep/cooking instructions, freezing instructions, serving instructions and containers needed for freezing. Users are able to also enter the serving amounts they need and the recipes will adjust accordingly. The system also accepts and automatically adjusts for user input of a number of servings needed.
Chopping List. The system also generates a list of items (such as ingredients) that should be cut or otherwise processed or prepared before starting a cooking day. This list identifies the items needed and automatically determines the quantity yielded once chopped or otherwise processed. For example, “2 green peppers, whole” yields “3 cups green peppers, diced.”
Grocery List. Based on the recipes and other parameters, the system generates a list of the items (in their “whole” form) that need to be purchased from the grocery store to complete the indicated menu. The system also dynamically adjusts the grocery list for the number of servings needed.
Step-by-Step Instructions. This set of instructions tells the user what to prepare/cook first, second, and so on and so forth. The system generates these instructions to create the efficiencies in the kitchen that can be desirable when someone is going to be in the kitchen for a length of time.
Labels. The system creates labels bearing the directions needed for preparing the dish on the “serving day.” These labels allow the user to label their meals before they are frozen for ease of use when they are pulled from the freezer.

### System Overview

The “MENUBUILDER” application allows users to build or customize freezer menus based on user- and/or system-selected recipes. As the user selects recipes to add to their menu, the system provides feedback on the resulting menu. After each change, the system validates the resulting menu based on the system's business rules for a complete menu that can be prepared in a single cooking day. While the system is continuously validating, it provides feedback to the user to guide them toward creating or customizing an optimal freezer cooking menu.

After building the desired menu, the system produces “cooking day artifacts” for the user. These artifacts include a shopping list that groups like ingredients for easier shopping, freezer labels, a “chopping list” of how to prepare ingredients into what the recipes require, and detailed cooking instructions for preparing the menu on a single cooking day. The detailed cooking instructions walk the user through how to complete a freezer cooking day in an optimal way, considering the practicalities of limited preparation resources, such as managing oven space and temperature changes), and the like.

### Menubuilder

### Description

With reference to FIG. 1, the MENUBUILDER component 102 of menu-building web application 110 allows members to create a freezer-suitable menu of their preferred recipes in the appropriate quantities for their specific use case. Once they're satisfied with the freezer cooking menu, they can request the web application 110 to generate the documents needed to cook the dishes for the target period in a single cooking day. For example, shopping list and chopping list creator module 104, cooking day instruction creator 106, and meal scheduling and notification system 108 each provide their respective outputs based on the selected menu and data stored, for example, in persistent storage unit 120. In the illustrated embodiments, individuals access the web application 110 using a user agent 130 via the Internet 140, though other access techniques and application structures will occur to those skilled in the art in view of this disclosure. Similarly, while the present embodiment uses third-party SMS service 150 to send text-message notifications, other notification techniques, such as smart phone push notifications, email, and other notice and notification systems will occur to those skilled in the art.

While in this illustrated embodiment certain system defaults allow users to jump right into choosing recipes for a new menu, users are also given the ability to customize the configuration of their cooking day by changing “menu options” 210, as shown on user interface (UI) screen 200 in FIG. 2. In this sense, the system helps the user balance “menu options” 210 by continually monitoring the number and type of recipes that make up a menu and the parameters that define the cooking day. This balance aids the creation or customization of a menu which can be prepped and cooked successfully. Additional, various, and more detailed options are presented through user interaction with advanced menu options panel 220, and system feedback on the currently selected options is reflected in feedback panel 230.

This balance can be seen in two components of the meal creation process in this illustrated embodiment: first, in a generic way in the “menu options” workflow; and second, in a specific way in the “menu recipes” flow. The system monitors the balance in both contexts and guides the user toward success.

### UX Walk-Through

with continuing reference to FIG. 2, users can decide to build a custom freezer cooking menu in a variety of ways:

choosing specifically to “create a new menu,”

finding a recipe they like and “creating a new menu using this recipe,”

finding a menu they like and “creating a new menu based on this menu,” and

other methods as will occur to those skilled in the relevant art.

The system then takes the user to the opening screen 200 for building that menu. Here, the user is prompted to title their menu and to choose both basic and advanced menu options. They begin by using drop-down UI elements 211 to choose the number of persons that they are cooking for or serving. They then select the number of breakfasts, lunches, dinners and/or snacks they would like using UI elements 213, 215, 217, and 219, respectively. The MENUBUILDER module 102 in this implementation has defaults for creating a full day freezer cooking menu, including: approximately 1-2 hours preparation, 10-12 hours of cooking time, and combine approximately 15 recipes, each of which will each be served twice (double portions of each) in the 30-day serving period. Users can create other variations of these parameter selections simply by adjusting the “menu options.”

As shown in FIG. 3, the basic and advanced menu parameters can be shown and selected together on UI screen 300 to determine whether the number of meals, for the number of people being served, can be prepared while meeting optimal freezer cooking formulas. (See “Technical Walk-Through” herein.) Advanced features in exemplary advanced options panel 310 indicate the resources, equipment and time available for a freezer cooking day, which ultimately impacts the overall ability to execute a given menu. Help text next to each advanced menu option gives the user information to help understand how the choices of each option affect the overall menu.
Cooking for—Number of total people the user wants to serve on their serving days (in this example, the default is 4).
Cooking with a group of—Number of individuals who will be cooking together on their cooking day (default is 2).
Cooking Day Lasting—Number of hours the user is willing to be in the kitchen preparing meals on their cooking day (default is 10-12 hours).
Serving Each Recipe—Number of times each meal will be served as a complete meal (default is 2).
Slow Cookers Available—Number of slow cookers that will be available during the cooking day (default is 2).
Ovens Available—Number of ovens available during a cooking day (default is 1).
“Throw and Go” Meals—Number of easy-to-assemble meals that will be on the menu (default is 6 or more).
   Before the user can begin adding recipes to a menu in this embodiment, a realistic balance must be achieved between the input (resources available for the cooking day) and output (number, preparation, and types of recipes) constraints. In the illustrated embodiment, feedback panels 230 and 320 in user interface screens 200 and 300, respectively, let the user know when the selective constraints are not feasible. In other embodiments, the system might issue a warning that can be dismissed or ignored, or parameter selections may be limited so that only feasible combinations of options can ever be selected.

Turning to UI screen 400 in FIG. 4, the system checks the basic menu options 410 with the advanced options 420 to determine whether the menu is in balance. If preprogrammed logical rules concerning feasibility are violated, users will be prompted in feedback panel 430 with directions for balancing their menu. The response will include suggestions for how they may choose better options. Though any option could be changed to fix the problem (for example, reducing the number of people being cooked for), the suggestions presented to the user prioritize things that are more likely to be flexible such as length of cooking day, number of recipes or amount of (easier) “throw and go” meals. See, for example, the feedback 510 provided in UI screen 500 of FIG. 5

When there are no longer any rule violations (the “menu options” are in balance), the “uh oh” prompt goes away from feedback panel 430, and a clickable “next step” button returns. In the illustrated system, users are not able to proceed to the next stage in building their menu until there are no violations. Violations at this stage mean it wouldn't be possible to prepare and cook the menu in its current state.

After having completed the “menu options,” the user proceeds to choosing “menu recipes” using user interface screen 600, illustrated in FIG. 6. At this stage, they are prompted with evaluations of the currently selected menu using several types of analysis to guide them in the selection of their recipes for the menu.
1 Cooking Time/Menu Difficulty indicators 610 and 620 provide running totals of calculated cooking time and menu difficulty as recipes are added.
2 The menu options the user selected (business rules) are summarized 630, so the user can refer to them while building the menu. This provides context for some of the errors and feedback they might get when selecting recipes, and gives users an opportunity to go back and edit them.
3 At any point, the user can move to the next step; however, if any of the menu option rules (see FIGS. 2-4) are being violated, they are identified and a warning is given in note block 64
4 If the user clicks the “Create Magic Menu” button 650 in screen 600, the system will fill out the rest of a menu (from completely empty, half-complete, etc.) with the user's favorites or earmarked recipes that are a best fit for the menu options. If not enough recipes are available that fit those criteria, the system will populate the menu with other recommended recipes that fit the menu options and follow user preferences. The proposed menu is then displayed, and the user has the ability to alter the final results.
5 “Add Recipe” button 660 is used when the user wants to create their own menu by selecting each recipe manually.

As the user chooses recipes, they receive immediate feedback on the following:
1 Cooking Time/Menu Difficulty indicators 610 and 620, respectively, are running totals of calculated cooking time and menu difficulty based on the recipes that the user has chosen to that given point.
2 Left To Add section 670 displays the number of meals that still need to be added to the suit their menu.
3 As shown in FIGS. 7-12, for each recipe in the “Menu Recipes” list 710 displays one or more recipe type icons 720 on UI screen 700 to indicate the cooking style(s) of the recipe chosen. The system uses rules to dictate the types of recipes that can be chosen to balance the “menu options” selected and to create an optimal menu.
   The following rules are implemented in this embodiment, though in other embodiments more, fewer, or different rules are implemented:

A “typical” 15-recipe menu should be made up of the following:
Baked Items—approximately 2.5 hours each (other items can be prepared while these are baking)—three, no more than four baked items per menu.
   The system assumes 2-3 hours baking time for each baked item. Often one is doubling a recipe or making more of a dish than normal, which usually requires several intervals of baking in the oven.
Slow Cooker Meals—approximately 4-6 hours (other items can be prepared while these are cooking)—one to two (depending on equipment available) that are cooking on the cooking day as the user works.
   These meals are prepared, placed in the slow cooker and cooked throughout the day, then frozen after the cooking has been completed.
Stovetop/Microwave—approximately 30 minutes to 3 hours—four to eight recipes.
   These are items that need some cooking before they are put into freezer bags and frozen.
No Cook and/or Easy Assembly—15 minutes to an hour—one to eight recipes.
   These have little to no cooking or preparation involved, the ingredients are simply combined and frozen.
Add-Ons—30 minutes to an hour—zero to five (The system will eliminate recipes in above categories if the user is using add-ons so the menu preparation does not exceed the available resources).
   Complimentary, made-from-scratch items.

When adding recipes to their menu, a user has several ways of finding a recipe to include. In the illustrated embodiment, the system's search facility yields results that:
match tags (managed by the system and/or by the user) that the user can select as filters for the result list;
match recipe names, ingredients, sources, ratings, or other properties of (or associated with) the recipes;

Users may also choose to limit search results by selecting check boxes associated with high-level content categories. For example, the illustrated embodiment includes checkboxes for “my earmarked recipes” and “my custom recipes” to get what could be considered a collection of the user's most liked recipes.

As recipes are chosen, icons appear to indicate the type of recipe chosen (baked, slow cooker, stovetop/microwave, no-cook, “throw and go”). If a recipe is added that results in the collection violating a rule (for example, based on the “menu options” that have been selected), the user will be alerted of the violation (see, for example, alert 910 on UI screen 900 in FIG. 9) and given the option to alter their “menu options” being violated (see button 920) or to choose one or more different recipes (see button 930). If the user chooses to overcome the issue by altering their “menu options,” they will be prompted with a notice that highlights and/or explains the violation, such as is illustrated with notice ball 1010 in UI screen 1000 shown in FIG. 10.

As a menu is built, the user is given dialogs and prompts that help them to determine whether their menu fits their criteria. They may move on to complete the menu and get the automatically produced resources at any point, but if there is a violation of any rules, the violation will be described to the user as a warning. For example, in FIG. 11, the user is prompted by note 1110 that they had wanted a 12-hour cooking day, but have currently selected recipes requiring 14 hours of preparation time.

When a user's menu lines up perfectly with the rules in place for “menu options” and “menu recipes” (see FIG. 4) they are prompted that this is a good menu and given the “green light” (see acceptance notice panel 1210 in FIG. 12) to proceed to the next step of creating their menu resources. Optionally, as shown in FIG. 13, a UI screen 1300 is displayed for input of menu details 1310, including for example a short description of the menu 1320, tags in UI section 1330, sharing options in UI section 1340, and/or menu manipulation options (e.g., for completing the menu and getting preparation resources, further customizing the menu before finalizing, saving the menu, and deleting the menu) as shown in UI section 1350.

Once a menu is completed, users can tag the menu with suggested tags as they type, custom-entered tags, and/or tags that are managed by the system. Users can also create custom tags, solely for their own use.

Menus in this system each have a status that is one of the following:
1 “In Progress” menus are under construction and are not visible to anyone other than the user working on them. Output resources are not yet available for “in progress” menus.
2 “Complete” menus have been saved, and the associated output resources have been made available. Complete menus are also viewable to others if the user has given permission to others to view them.

### Technical Walk-Through

At the core of the menu building web application 110 (see FIG. 1) is a rules engine that is consulted each time the member makes a change, allowing the system to provide feedback to the user as to progress toward a complete menu and/or conflicts with menu development constraints. In this embodiment, the rules engine takes into account the individual user's preferences for the cooking day or the default system cooking day preferences. Each time the menu is edited, the rules engine runs.

The menu-building web application 110 (see FIG. 1) guides the user through building a freezer cooking menu based on the default parameters, the user's individually selected settings, or a combination thereof. Even in the event of a problem or conflict between the selections and rules, the illustrated embodiment does not prevent the user from completing their menu, but makes recommendations to the user that would ameliorate the issues.

The rules engine totals together the cooking/preparation time of the all selected recipes, as will be understood by those skilled in the art. The system takes into account which items can be cooked/prepared at the same time and determines the total cooking time. It does this by running through the algorithms that are part of the “menu instructions” component. In this implementation, the system partially builds the cooking day instructions to determine the total cooking time.

The system tracks the number and type of meals selected and informs the user as they build the menu just how many of each meal type are needed to fill the menu.

The system keeps track of the different recipe cooking styles so that the user does not knowingly over commit to too many of one cooking style based on the “menu options” for the corresponding menu (for example, with one oven the typical cooking day should not have more than three or four baked items).

Based on the total cooking day time, recipe cooking style (baked, slow cooker, stove top, no cook, “throw and go”) and meal type (breakfast, lunch, dinner or snack) the system will be able to suggest recipes that fit with the menu.

Along with the ability to suggest recipes that fit the remaining menu requirements at a given time during development of the menu, the system has the ability to “auto complete” the recipe selection. This starts with the recipes that have been earmarked or “favorited” by the user. If the system needs more recipes than are available in these lists, or if the recipes on the earmarked list and the favorites list are not good fits for the remaining menu spots, the system fills the spots with new recipes that have been added to the site. This continues until all of the recipe spots are filled and the menu meets the constraints set by the user.

Example pseudo-code for automatic addition of recipes to complete a menu is as follows:

```
While the menu is not complete {
  Check earmarked recipes for good fit starting at the oldest added recipe
  Check the favorites recipes list for a good fit starting at the one that was
  on the oldest user menu
  Check the site recipes list for a good fit starting at the most recently
  selected recipe
}
```

Other algorithms may be used as will occur to those skilled in the art in view of this disclosure.

### Chopping & Shopping Lists

### Description

The system automatically generates a list of food preparation steps that includes automatic conversion between units of food as purchased and units of food as processed (i.e., a “chopping list”) based on the generated menu. When preparing for and executing a freezer cooking day (multiple recipes being completed over the span of many hours), it is helpful to have both a shopping list of items for the grocery store as well as a chopping list of ingredients that need to be processed or otherwise prepared for using in recipes. For example, whole items need to be purchased at the grocery store, but for completing multiple recipes using the same item the items should be quantified by measurement (teaspoons, tablespoons, cups).

The system creates both a grocery list for purchasing whole items when shopping, but will then quantify each of the ingredients by preparation type (diced, sliced, chunks, minced) on a chopping list and on the recipe cards based on the generated menu. This implementation is mostly used for items that need preparation for cooking day (chopped/shredded meats, produce, fresh spices, nuts, etc.).

In addition, the system allows some or all users the ability to switch between Imperial and metric measurement systems for purchasable items, an ability to link the grocery list with local grocery sales, etc.

### UX Walk-Through

The final result is a menu displayed with the Menu Title 1610, Creator's Username 1620, Menu Options 1630, visual display of recipes 1640 and ability for others to rate the menu if it is public 1650, all as illustrated in FIG. 16. From this screen, the user can choose to edit this menu further (1660) or ready the available resources for completing the Cooking Day (1670). The user is given the option of several formats for receiving their resources (e.g., print, pdf, sending to eReader, viewing in browser). Once the format is chosen, they are given additional parameters to choose (1710) as seen in the example of printing illustrated in FIG. 17.

The system automatically generates a list of food preparation items needed that includes automatic conversion between units of food as purchased on the grocery list and units of food as processed on the chopping list for use in preparing the recipes on the generated menu. Whole items need to be purchased at the grocery store, but for preparing multiple recipes using the same item the items need to be quantified by measurement (teaspoons, tablespoons, cups). For example, on the sample grocery list and chopping list, 4.5 carrots are needed (this system will list that as 5 carrots), but on the chopping list we see that 4 sliced carrots are needed and 0.5 shredded carrot is needed. This equates to 2.68 cups of sliced and 0.25 cups of shredded. These converted quantities are what will be needed to properly execute recipes on the cooking day.

### Technical Walk-Through

Turning to FIG. 18, to create the shopping list and the chopping list, the system reduces all of the included recipes 1810 down to their ingredients 1820. From there the system looks up the ingredient and the ingredient preparation and determines the ingredient equivalency 1830. The ingredient equivalency 1830 is able to convert from the amount specified in the recipe 1810 to the unit of food to be purchased. This is then done for every recipe in the menu 1840 at the correct quantity and added together. The total mathematical result is rounded up to the next purchasable unit.

For example, if a recipe's instructions 1850 call for ⅓ cup of sliced onions, it is represented in this way:

| 0.33 | Cup | Onions | Sliced |
|---|---|---|---|
| This is part of the | Normalized | Normalized | Normalized Prep- |
| recipe | Measurement | Ingredients | type |

This format allows the system to look at multiple recipes and know that they all include the same ingredient—in this example, “onions.” Then the system takes the measurement and ingredient prep type 1860 and looks at the equivalency, which tells us that ⅓ cup of is equal to ½ medium onion to be purchased at the store.

This same logic is used for each ingredient 1820 in all recipes 1810 for a given menu 1840, which results in whole unit totals for the recipes. Then the system adds all like ingredients together to create the shopping list. The final step is to make sure that all of the ingredients are in whole amounts, which is done by rounding the final total up to the next purchasable unit.

Using the above logic and combining ingredients that are prepared the same way yields the chopping list. For example, if we have 2 recipes that each need to have ½ cup of sliced onions, then the chopping list should state that we should prepare 1 cup of sliced onions. Using an equivalency table, as will occur to those skilled in the art, we can then tell the user that 1 cup of sliced onions should be 1.5 medium onions.

Additionally, the data format of the ingredients allows us to easily switch between Imperial and metric measurement systems.

### Freezer Cooking Day Preparation & Instructions

### Description

This resource is one of the items the system generates that is especially beneficial to freezer cooking. One part of executing an effective and timely freezer cooking day is not only to properly select recipes (as outlined above) but also to execute completion of those recipes on the cooking day. When building freezer cooking instructions, the system considers the order of operations needed to complete these recipes efficiently.

The user's chosen menu options are taken into account here to yield instructions. For example, the system might give instructions for having two partners instead of one partner.

### UX Walk-Through

The user gains access to the Instructions in the same way they access all other resources, that is, by selecting the format they'd like them in from the “Available Resources” section of the “Menu Page” (see FIGS. 16-17).

### Technical Walk-Through

One aspect of executing an effective and timely freezer cooking day is not only in the proper selection of recipes (outlined above) but another is in the execution of how those recipes get completed on the cooking day. When building freezer cooking instructions it is important to consider the order of operations needed to complete these recipes.

The following explains how freezer cooking menu instructions are built for a selected combination of recipes in this illustrated embodiment:
Night Before Instructions—this includes any items that need to be cooked overnight in a slow cooker or baked the night before. It also includes all chopping that needs to be done per the chopping list.
   For example, if 6 pounds of cooked chicken are needed on the cooking day, users are instructed to cook that overnight in a slow cooker so that it is ready at the start of their cooking day the next morning.
Cooking Day Steps Now Begin
   First steps include cleaning out the slow cooker if used the night before and starting any slow cooker recipes that were selected for cooking day.
   Begin preparing baked items on the menu, beginning with the item that uses the lowest baking temperature (Baked Item #1).
   Baked Item #1 is placed in the oven for indicated number of minutes for as many rounds as needed to complete all items being made.
   While Baked Item #1 is baking in the oven, the next baked item is being prepared and readied for the oven.
   Baked Item #1 is removed from oven to cool. Flash freeze if the recipe indicates it.
   If the temperature for baked item #2 is greater than that of baked item #1 then the system instructs users to turn the oven up to the indicated temperature. If no increase is required, no instruction is given.
   Place Baked Item #2 in oven for indicated number of minutes for as many rounds as needed to complete all items being made.
   If a third baked item (#3) is in the menu, begin preparing that item while Baked Item #2 is baking. If not, proceed to preparing Stove Top #1. (Stove Top recipes are rated on most time-intensive to least time-intensive.
   When Baked Item #2 is done baking, remove it from the oven and allow it to cool. Flash freeze if the recipe indicates it.
   If a Baked Item #3 is selected and the baking temperature is greater than that of Baked Item #2, then they automatically generated instructions will cue the users to turn the oven up to the indicated temperature. If no increase is required, no instruction is given.
   (If chosen) Baked Item #3 is placed in the oven for the indicated number of minutes for as many rounds as needed to complete all of the items being made.
   [Similar steps are executed if there is a Baked Item #4]
   Proceed through Stove Top Items selected for the menu from most intense (time/effort) to least intense.
   Package and freeze any cooking Baked Items from above.
   Package and freeze remaining no-cook and easy-assembly recipes. Group assembly of these items by meat item (vegetarian, cooked meats, seafood, beef, pork, poultry) to prevent cross-contamination.
   The last steps is always “Clean up kitchen, and you are done.”
Some embodiments will adapt instructions for cooking with multiple people (e.g., a main cook and a partner), indicating what one of the individuals does while the other does something else.

### Calendarization & Notification System

### Description

One of the most useful features of certain implementations of the present system is the ability for the member to be notified throughout the month as their scheduled meals need some preparation. For example, because this is a freezer-oriented cooking system, the various ingredients for a specific meal may need to thaw the day before preparation. If the member identifies the calendarization of their meals, the system will be able to notify them via their chosen medium when these kinds of actions are required.

As shown, for example, in FIG. 14, the user can choose to indicate the following on their Calendarized Menu 1410:
When the menu cooking day is taking place.
When they are eating the meals that they have selected on their freezer cooking menu.
   Additionally, this calendar can be imported into the user's other calendar applications (example, Google Calendar, iCal) using button 1420. This functionality will also result in the user getting notifications, such as SMS or emails (see FIG. 15), related to the Cooking Day (UI region 1510) or the Serving Day (UI region 1520) as scheduled on their calendar.

### Technical Walk-Through

Returning to FIG. 14, once the user has completed building their menu, they can choose to schedule their cooking day and calendarize their meals. The user can either manually schedule the meals or have the system schedule the meals for them.

If the system schedules the meals, it will start with the first recipe added to the menu and add subsequently added recipes to open days after the cooking day. The system will ensure that the same meal is not served twice in the same week.

Since the system now knows what days they are planning on eating which meals, it can send the user notifications in advance of each serving Day. In the present embodiment, notifications will be sent via email or a third-party SMS service, though in other embodiments different or additional notification techniques may be used. Notifications in the present embodiment include what needs to be thawed the night before and when a meal needs to be cooked (if it is a slow cooker meal and needs to cook all day, for example) as well as other time-sensitive messages. These notifications are driven from the recipe instructions and the information in the schedule.

While the invention has been illustrated and described in detail in the drawings and foregoing description, the same is to be considered as illustrative and not restrictive in character, it being understood that only the preferred embodiment(s) have been shown and described and that all changes and modifications that come within the spirit of the invention are desired to be protected.

What is claimed is:

1. A system, comprising a processor and a memory in communication with the processor, the memory storing programming instructions executable by the processor to:
accept selection by a user of a plurality of recipes;
automatically produce a combined list of preparation steps effective to achieve the same result as the combination of the plurality of preparation steps for the selected plurality of recipes; and
output the combined list.

2. The system of claim 1, wherein:
the plurality of preparation steps in the selected plurality of recipes collectively use one or more preparation resources; and
the automatic production of a combined list comprises automatically organizing preparation steps for efficient use of the one or more preparation resources.

3. The system of claim 2, wherein the one or more preparation resources are selected from the group consisting of:
an oven;
a mixer;
counter space;
one or more slow cookers; and
one or more stove-top burners.

4. A non-transitory, computer-readable medium encoded with programming instructions executable by a processor to perform the operations listed in claim 1.

5. A system, comprising a processor and a memory in communication with the processor, the memory storing programming instructions executable by the processor to:
automatically generate and output a list of food preparation steps needed to make a plurality of dishes characterized by a corresponding plurality of recipes,
wherein said automatic generation comprises automatic conversion between units of food as purchased and units of food in processed form.

6. The system of claim 5, wherein the programming instructions are further executable by the processor to generate a shopping list of items, in units that can be purchased, for use in the food preparation steps.

7. The system of claim 6, wherein the programming instructions are further executable by the processor to generate a list of ingredient preparation tasks that convert ingredients from a purchased form into a second form that is directly usable in at least one of the food preparation steps.

8. The system of claim 7, wherein the programming instructions are further executable by the processor to combine purchase requirements for a particular raw material from a plurality of recipes into a single item in the shopping list of items.

9. The system of claim 8, wherein the particular raw material is prepared in at least two different ways in the plurality of recipes.

10. A non-transitory, computer-readable medium encoded with programming instructions executable by a processor to perform the operations listed in claim 5.

11. A system, comprising a processor and a memory in communication with the processor, the memory storing programming instructions executable by the processor to:
automatically generate and output a list of food preparation steps needed to make a plurality of dishes characterized by a corresponding plurality of recipes that have been selected at least in part by a user,
wherein the list of food preparation steps is organized to optimize the use of food preparation resources.

12. The system of claim 11, wherein the food preparation resources comprise baking resources.

13. The system of claim 11, wherein the food preparation resources comprise mixing resources.

14. The system of claim 11, wherein the food preparation resources comprise at least one slow cooker.

15. A non-transitory, computer-readable medium encoded with programming instructions executable by a processor to perform the operations listed in claim 11.
